(19) United States
(12) Patent Application Publication
(10) Pub. No.: US 2011/0279464 A1
(43) Pub. Date: Nov. 17, 2011

(54) Auto Double Buffer in Display Controller

(75) Inventors: Kenneth J. Klask, San Jose, CA (US); Teresa Bodo, Mountain View, CA (US)

(73) Assignee: AMULET TECHNOLOGIES, LLC, Santa Clara, CA (US)

(21) Appl. No.: 12/778,050

(22) Filed: May 11, 2010

(51) Int. Cl. G09G 5/36

(52) U.S. Cl. 345/545

(57) ABSTRACT

In a double buffering technique, a display controller refreshes a display from a first frame buffer by default and a processor draws into a second frame buffer. When the processor finishes drawing the second frame buffer, the processor signals the display controller that a new frame is ready in the second frame buffer. In response, the display controller refreshes the display from the second frame buffer and concurrently copies each line into the first frame buffer. After the display controller refreshes one entire frame, a complete copy of the frame is available in the first frame buffer so the display controller returns to refreshing the display from the first frame buffer and the processor is able to draw to the second frame buffer.

### FIELD OF INVENTION

This invention relates to a display controller, and more specifically to a display controller that uses a double buffer technique to eliminate tearing or flickering and reduce processor copy or redraw cycles.

### DESCRIPTION OF RELATED ART

Displaying a dynamically changing image on a display can cause tearing or flickering. Tearing or flickering occurs because the display is being repeatedly refreshed at the same time the displayed image is being drawn or changed. A common solution to this problem is called double buffering. FIGS. 1 to 4 illustrate conventional double buffering performed in hardware.

FIG. 1 shows a double buffering method 100 performed by a processor 202 and a display controller 204 to refresh a display 206 in a system 200 illustrated in FIGS. 2 and 3. In block 102, processor 202 draws a new image into frame buffer A (208) or redraws a portion of an existing image in frame buffer A. In a block 104 that occurs in parallel with block 102, display controller 204 refreshes display 206 from a frame buffer B (210) at a certain frame rate. Display controller 204 is selectively coupled to either frame buffer A or frame buffer B by a multiplexer 212. Blocks 102 and 104 are illustrated in FIG. 2.

In block 106 that follows block 102, processor 202 copies the image from frame buffer A to frame buffer B. Processor 202 has to start with an initial image as the base before any updates or modifications can be made to the image to prevent tearing. There are two ways to get the initial image: (1) by copying from the other frame buffer or (2) by redrawing the whole image. These two processes double the work for processor 202 because the processor has to draw or copy images to both frame buffers so that display controller 204 can refresh from the frame buffer that the processor 202 is not drawing into.

By copying the image to frame buffer B, processor 202 only has to redraw a portion of the image instead of the entire image when the image is updated. As it takes many processor cycles to copy the image from frame buffer A to frame buffer B, processor 202 is not free to work on other processes.

To redraw the image from scratch, processor 202 draws the image straight into frame buffer B. It also takes many processor cycles to redraw the whole image from scratch and prevent processor 202 from working on other processes.

In block 108 that follows block 106, processor 202 draws a new image into frame buffer B or redraws a portion of an existing image in frame buffer B. In a block 110 that occurs in parallels with block 108, display controller 204 refreshes display 206 from frame buffer A instead of frame buffer B. Blocks 108 and 110 are illustrated in FIG. 3.

In block 112 that follows block 108, processor 202 copies the image from frame buffer B to frame buffer A and then notifies display controller 204 to refresh display 206 from frame buffer B. Again, as it takes many processor cycles to copy the image from frame buffer B to frame buffer A, processor 202 is not free to work on other processes. The blocks of processor 202 and display controller 204 then repeat as described above.

FIG. 4 illustrates components of a conventional display controller 204. Display controller 204 includes an image line grabber 402 that retrieves one image line at a time from frame buffer A or frame buffer B. Image line grabber 402 stores the image line in a line buffer 404. A display data formatter 406 retrieves the image line from line buffer 404, converts each pixel from the image line into color components, and arranges the color components into the proper display order for display 206. A timing and control signal generator 408 provides the timing and control signals to image line grabber 402, display data formatter 406, and display 206 to output image lines for refreshing the display.

In view of above, what are needed are double buffering method and apparatus that prevents tearing or flickering without slowing down the processor.

### BRIEF DESCRIPTION OF THE DRAWINGS

In the drawings:

FIG. 1 is a flowchart of a conventional hardware method for double buffering;

FIGS. 2 and 3 illustrate a system performing the blocks of the method of FIG. 1;

FIG. 4 is a block diagram of a conventional display controller;

FIG. 5 is a flowchart of a hardware method for double buffering in one or more embodiments of the present disclosure;

FIGS. 6 and 7 illustrate a system performing the blocks of the method of FIG. 1 in one or more embodiments of the present disclosure; and

FIG. 8 is a block diagram of a conventional display controller in one or more embodiments of the present disclosure.

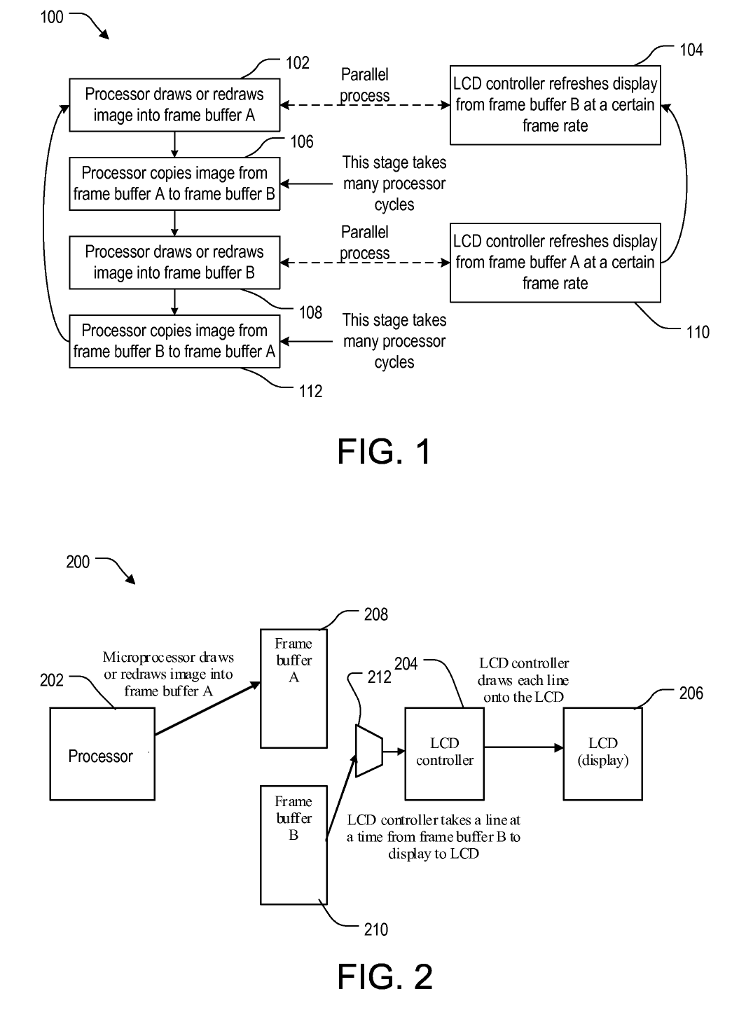

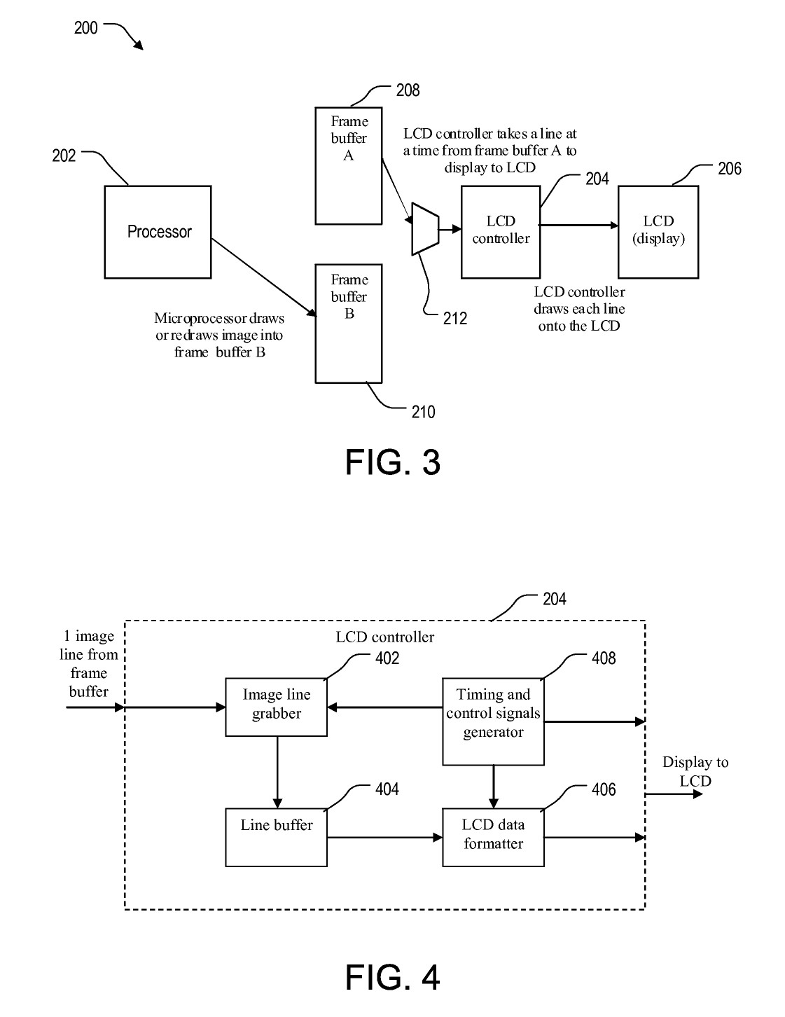

Use of the same reference numbers in different figures indicates similar or identical elements.

### DETAILED DESCRIPTION

In one or more embodiments of the present disclosure, a double buffering technique includes a display controller that refreshes a display from a first frame buffer by default and a processor that draws into a second frame buffer. When the processor finishes drawing the second frame buffer, the processor signals the display controller that a new frame is ready in the second frame buffer. In response, the display controller refreshes the display from the second frame buffer and concurrently copies each line into the first frame buffer. After the display controller refreshes one entire frame, a complete copy of the frame is available in the first frame buffer so the display controller returns to refreshing the display from the first frame buffer and the processor is able to draw to the second frame buffer.

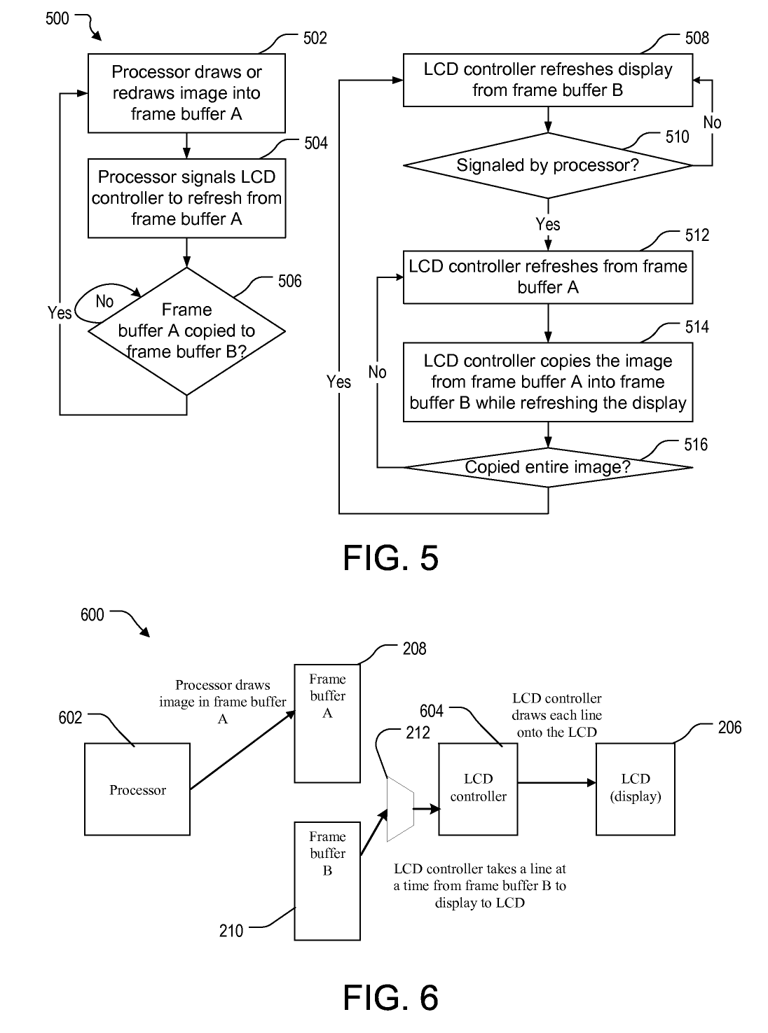

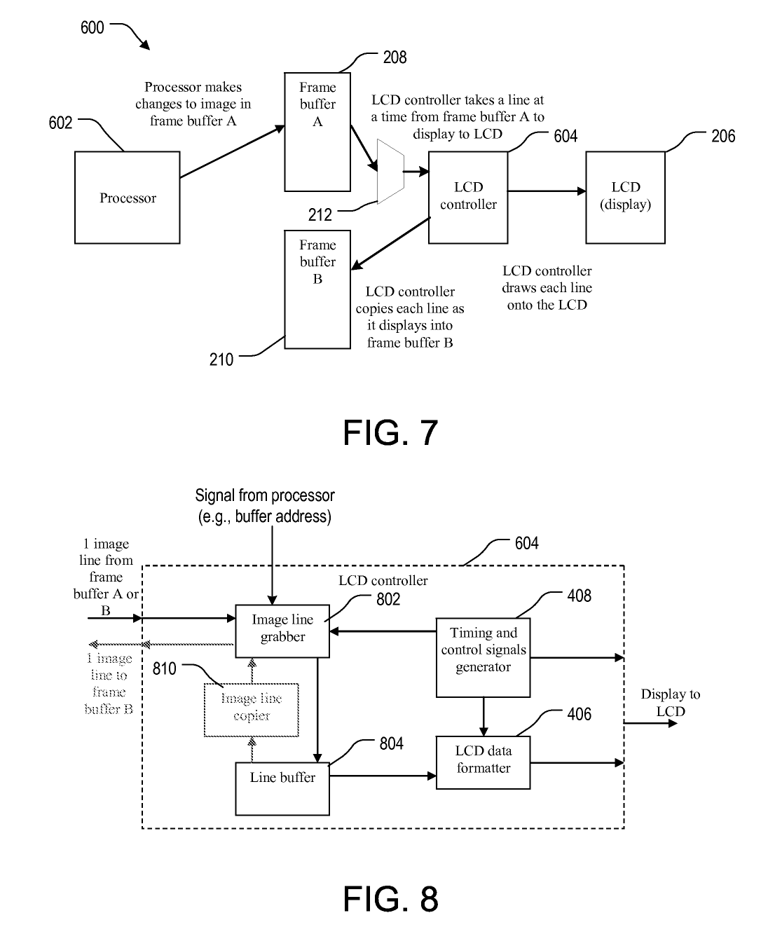

FIG. 5 is a flowchart of a double buffering method 500 in one or more embodiments of the present disclosure. Method 500 is performed by a processor 602 and a display controller 604 to refresh display 206 in a system 600 illustrated in FIGS. 6 and 7 in one or more embodiments of the present disclosure. System 600 may be implemented in any system that requires a processor, and display controller, and a display. For example, system 600 may be the control system in any appliance.

Method 500 may comprise one or more operations, functions, or actions as illustrated by one or more of blocks. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 500 may begin in block 502.

In block 502, processor 602 updates frame buffer A (208) by drawing a new image into frame buffer A or redrawing a portion of an existing image in frame buffer A. Frame buffer A serves as a secondary buffer. Processor 602 typically updates frame buffer A in response to an application it is executing. Processor 602 only draws to frame buffer A and does not have to copy the image to frame buffer B (210) or draw to frame buffer B. This saves many processor cycles so that processor 602 is free to work on other processes. During this time, display controller 204 is coupled by multiplexer 212 to refresh from frame buffer B. This block is graphically illustrated in FIG. 6. Block 502 may be followed by block 504.

In block 504, processor 602 signals display controller 604 to refresh from frame buffer A when the processor finishes drawing or redrawing the image in frame buffer A. For example, processor 602 provides display controller 604 an address in frame buffer A to read. Block 504 may be followed by block 506.

In block 506, processor 602 determines if display controller 604 has copied the image in frame buffer A to frame buffer B (described later). Processor 602 knows display controller 604 has copied the image from frame buffer A into frame buffer B when a known amount of time it takes to copy the image has passed. Alternatively, display controller 604 may signal processor 602 that the image has been copied. If display controller 604 has copied the image in frame buffer A to frame buffer B, block 506 may be followed by block 502 where processor 602 may update frame A when necessary. Otherwise block 506 may loop back to itself until display controller 604 has copied the image in frame buffer A to frame buffer B.

In block 508, display controller 604 operates in a default mode where it refreshes the display 206 from frame buffer B. Frame buffer B serves as the primary frame buffer. Display controller 604 retrieves one image line at a time from frame buffer B and refreshes the corresponding display line in the display 206 with the retrieved image line. Display controller 604 is selectively coupled to frame buffer B by multiplexer 212. This block is shown in FIG. 6. Block 508 may be followed by block 510.

In block 510, display controller 604 determines if it has been signaled by processor 602 to refresh from frame buffer A. If so, block 510 may be followed by block 512. Otherwise block 510 may loop back to block 508 where display controller 604 continues to refresh display 206 from frame buffer B.

In block 512, display controller 604 operates in a refresh mode where it refreshes display 206 from frame buffer A instead of frame buffer B. Display controller 604 signals multiplexer 212 to couple to frame buffer A instead of frame buffer B. Display controller 604 retrieves one image line at a time from frame buffer A and refreshes the corresponding display line in display 206 with the retrieved image line. Block 512 may be followed by block 514.

In a block 514 that occurs in parallel to block 512, display controller 604 copies the image in frame buffer A to frame buffer B while the display controller refreshes display 206 from frame buffer A. Display controller 604 copies one retrieved image line at a time to frame buffer B. Blocks 512 and 514 are illustrated in FIG. 7. Block 514 may be followed by block 516.

In block 516, display controller 204 determines if the entire image has been copied from frame buffer A to frame buffer B. If so, block 516 loops back to block 508 where display controller 604 operates in the default mode to refresh display 206 from frame buffer B. Display controller 604 would signal multiplexer 212 to couple to frame buffer B instead of frame buffer A. As described above, display controller 604 may also signal processor 602 that the entire image has been copied. If the entire image has not been copied from frame buffer A to frame buffer, block 516 may loop back to blocks 512 and 514 where display controller 604 continues to operate in the refresh mode to refresh display 206 from frame buffer A and to copy the image from frame buffer A to frame buffer B.

FIG. 8 illustrates components of a display controller 604 in one or more embodiments of the present disclosure. Display controller 604 includes an image line grabber 802, a line buffer 804, display data formatter 406, timing and control signal generator 408, and an image line copier 810. Image line grabber 802 has a data input selectively coupled by multiplexer 212 (FIG. 7) to frame buffer A or B. Image line grabber 802 has a control input coupled to processor 602. Image line grabber 802 has an output coupled to frame buffer B to send copied image lines (described later). Line buffer 804 has an input coupled to image line grabber 802. In one or more embodiments of the present disclosure, line buffer 804 is a dual port random access memory (RAM). Display data formatter 406 has an input coupled to line buffer 804. Display data formatter 406 also has an output coupled to display 206 (FIG. 7). Timing and control signal generator 408 has outputs coupled to image line grabber 802, display data formatter 406, and display 206. Image line copier 810 has an input coupled to line buffer 804. Image line copier 810 also has an output coupled to image line grabber 802.

Display controller 604 normally operates in the default mode. In the default mode, image line grabber 802 retrieves one image line at a time from frame buffer B and stores the image line in line buffer 804. Display data formatter 406 retrieves the image line from line buffer 404 and puts it in the appropriate format for display 206. Timing and control signal generator 408 provides timing and control signals to image line grabber 802, display data formatter 406, and display 206 to output image lines for refreshing the display.

Display controller 604 operates in the refresh mode when processor 602 completes drawing or redrawing an image in frame buffer A. In the refresh mode, image line grabber 802 retrieves one image line at a time from frame buffer A instead of frame buffer B, and stores the image line in line buffer 804. Image line copier 810 reads the image line from line buffer 404 and outputs the image line to image line grabber 802. Image line grabber 802 writes the copied image line into frame buffer B once signaled by processor 602. The other components operate in the same manner as they would in the default mode. Once the entire image has been copied from frame buffer A to frame buffer B, display controller 604 returns to the default mode where it refreshes display 206 from frame buffer B. Display controller 604 may include a counter that keeps track of the copy process and signals processor 602 when the copy process is complete.

Various other adaptations and combinations of features of the embodiments disclosed are within the scope of the invention. Numerous embodiments are encompassed by the following claims.

What is claimed is:

1. A method for a display controller to refresh a display from a first frame buffer or a second frame buffer, the method comprising:
the display controller refreshing the display from the first frame buffer;
when the display controller receives a signal:
the display controller refreshing the display from the second frame buffer instead of the first frame buffer;
the display controller copying an image in the second frame buffer to the first frame buffer; and
when the image is completely copied to the first frame buffer, the display controller returning to refreshing the display from the first frame buffer.

2. The method of claim 1, wherein:
said refreshing the display from the second frame buffer comprises the display controller retrieving one line of the frame at a time from the second frame buffer; and
said copying an image in the second frame buffer to the first frame buffer comprises the display controller copying one retrieved line at a time to the first frame buffer.

3. The method of claim 2, further comprising:
the processor drawing the image into the second frame buffer; and
when the image is complete, the processor generating the signal to the display controller.

4. The method of claim 3, further comprising:
the processor drawing an other image into the second frame buffer;
when the other image is complete, the processor generating an other signal to the display controller;
when the display controller receives the other signal:
the display controller refreshing the display from the second frame buffer instead of the first frame buffer;
the display controller copying the other image in the second frame buffer to the first frame buffer; and
when the other image is completely copied to the first frame buffer, the display controller returning to refreshing the display from the first frame buffer.

5. A system for selectively refreshing a display from a first frame buffer or a second frame buffer, comprising:
a display controller, comprising:
an image line grabber having a first input selectively coupled to the first frame buffer or the second frame buffer, a second input coupled to receive a signal, and an output coupled to the first frame buffer;
a line buffer having an input coupled to the image line grabber; and
a line copier having an input coupled to the line buffer and an output coupled to the image line grabber.

6. The system of claim 5, wherein the display controller refreshes the display from the first frame buffer by default and from the second frame buffer in response to the signal, the image line grabber retrieves one image line at a time from the first or the second frame buffer and stores the image line in the line buffer, the line copier copies the image line in the line buffer to the image line grabber, the image line grabber writes the image line to the first frame buffer when the display controller is refreshing the display from the second frame buffer in response to the signal.

7. The system of claim 6, wherein the display controller further comprises:
a display data formatter coupled to the line buffer and the display; and
a timing and control signal generator coupled to the image line grabber, the display data formatter, and the display.

8. The system of claim 7, further comprising a processor, wherein the processor draws an image into the second frame buffer and generates the signal once the image is complete.
